(19) United States
(12) Patent Application Publication
(10) Pub. No.: US 2026/0329412 A1
(43) Pub. Date: Oct. 22, 2026

(54) SYSTEMS AND METHODS FOR GENERATING GRAPHICAL REPRESENTATIONS OF SEARCH RESULTS

(71) Applicant: SABIC Global Technologies B.V., Bergen OP Zoom (NL)

(72) Inventors: Flor Alba Castillo, Sugar Land, TX (US); Christian Andrew Wold, Bergen OP Zoom (NL); Krishnan Sankara-Narayanan, Houston, TX (US)

(21) Appl. No.: 19/113,298

(22) PCT Filed: Oct. 3, 2023
(86) PCT No.: PCT/US2023/075782

§ 371 Date: Mar. 19, 2025

Related U.S. Application Data
(60) Provisional application No. 63/378,133, filed on Oct. 3, 2022.

(51) Int. Cl. G06F 3/0482; G06F 16/338; G06F 16/35

(52) U.S. Cl. CPC G06F 3/0482; G06F 16/338; G06F 16/35

(57) ABSTRACT

Disclosed here are methods and systems for generating a one or more graphical representations of search results. In an embodiment, a method includes generating search results. The method includes extracting metadata from the search results to generate one or more classifiers. The method includes determining one or more graphical representations of the search results based on the one or more classifiers. The method includes displaying the one or more graphical representations to a user interface. The method further includes, in response to a selection of a data point, displaying the displayed graphical representations with emphasized portions based on the selection of the data point. The method includes emphasizing additional portions based on further selections of other data points.

### FIELD OF DISCLOSURE

The present disclosure generally relates to systems and methods for generation of graphical representations of search results and, particularly, to systems and methods for generation of interactive and/or dynamic graphical representations of semantic search results.

### BACKGROUND

Typically, a user may submit a search (such as a document search) by submitting a search query via user interface and/or web browser. After submission of the search query, the user may receive the search results in the form of a static list or static tabular list. The document search, in particular an enterprise-based document search, can result in a plurality of returned documents of different formats for a given search query. In some examples, the numerous results and the format of those results may cause issues due to the amount of time and effort a user may take to understand the search results. In other words, to understand the search and/or find documents or results desired, a user may open and review each document and decide whether a document provides the information sought. Further, some users may limit review to the first few search results, which may not provide the information sought.

### BRIEF SUMMARY

In view of the foregoing, Applicant has recognized these problems and others in the art, and has recognized a systems and methods for generation of graphical representations of search results and, particularly, to systems and methods for generation of interactive and/or dynamic graphical representations of semantic search results for a search query, an enterprise search query, and/or a document search query.

The present disclosure generally relates to a system that addresses the relevant issues as described above. In particular, the system may enable substantially real-time generation and display of interactive and/or dynamic graphical representations of semantic search results for a search query, an enterprise search query, and/or a document search query. Such a system may be configured to receive search queries of a set of data or searchable data, for example, through a user interface (for example, a graphical user interface or web-based user interface), from one or more computing devices. The search queries may be submitted to a search circuitry and/or search instructions. The search circuitry and/or search instructions may produce a set of search results or semantic search results (for example, a list of documents including links to such documents, a list of websites (for example, internal and/or external. The search circuitry and/or search instructions may then receive extracted metadata from a set of pre-extracted or pre-processed metadata (for example, the pre-processing based on a document set or entire document set) based on the set of data and/or extract metadata in real-time (for example, via a natural language processing (NLP) algorithm). In an embodiment, a machine learning model or the NLP algorithm may utilize the metadata extracted in real-time and/or pre-extracted data to produce, for example, topics for each document. Using the extracted or pre-extracted metadata, the search circuitry and/or search instructions may generate one or more classifiers for each result of the semantic search results. In other words, each result may include a number of specified classifiers describing and/or indicating various qualities and/or identifiers related to the search results (for example, who wrote the document, when the document was written, when the document was published, the region or country of origin, the topic or subject of the document, keywords associated with the document, among other factors).

A graphing circuitry and/or graphing instructions may determine one or more graphical representations based on the one or more classifiers for each result of the semantic search results. In embodiments, for example, the graphing circuitry may determine that, based on the one or more classifiers, that a particular graphical representation may be generated for the search results (for example, a graphical representation based on the number of documents per author, per publication year, per keyword, and/or per topic. The determined one or more graphical representations may be displayed, via a user interface (for example, a graphical user interface or a web user interface), to a user. In an embodiment, a user may choose or select which type of graphical representations to display prior to and/or after submitting a search query. The one or more graphical representations may be interactive and/or dynamic (for example, the graphing circuitry and/or graphing instructions may determine and/or generate one or more interactive and/or dynamic graphical representations). For example, a user may select any data point and/or portion of each displayed graphical representation. Upon or in response to a first selection, the graphing circuitry and/or graphing instructions may determine and/or generate one or more new graphical representations. The one or more new graphical representations may include highlighted portions of the data point and/or portion of the graphical representation selected. For example, a selected author may highlight any document in the graphical representations including that author. The user may then select the same data point and/or portion. Based on such a selection, the graphing circuitry and/or graphing instructions may generate one or more new graphical representations showing search results including the first selection and removing results lacking the first selection. In an embodiment, the user may select a different data point and/or portion and the graphing circuitry, in response, may determine one or more graphical representations with emphasized portions based on the first selection and the second selection, as well as, in some examples emphasized portions based on overlapping portions of the first selection and second selection.

In an embodiment, the search circuitry and/or search instructions may be configured to, in response to a selection of a data point and/or portion of one of the one or more graphical representations, generate new semantic search results. The search circuitry and/or search instructions may receive or access pre-extracted metadata and/or extract metadata and, based on the metadata, generate new one or more classifiers. The graphing circuitry and/or graphing instructions may then generate one or more new graphical representations.

In another embodiment, the graphical representations may include different types of graphs, each displayed via the user interface, such as bar charts, pie charts, line graphs, clusters, and so on. The user interface may additionally include a list button and/or a download button. The graphing circuitry and/or graphing instructions may, in response to selection of the list button, generate a tabular list of the associated search results. As a user selects different data points in the graphical representations, the corresponding tabular list may be based on the sub-set of search results representing the user selection of a data point. As a user selects the download button, the graphing circuitry and/or graphing instructions may prompt or initiate a download of the associated search results in a default or selected format.

Accordingly, an embodiment of the disclosure is directed to a method for generating one or more dynamic graphical representations of semantic search results. The method may include, in response to reception of a search query by a search circuitry, in substantially real-time, generating, via the search circuitry, semantic search results. The method may include receiving or accessing metadata or pre-extracted metadata and/or extracting metadata in real-time and, based on the metadata, generate one or more classifiers for each result of the semantic search results. The method may include determining, via a graphing circuitry, one or more graphical representations of the semantic search results based on the one or more classifiers for each result of the semantic search results. The method may include displaying, via the graphing circuitry to a user interface, each of the one or more graphical representations. The method may include, in response to a first selection of a first data point in the displayed graphical representations by a user, displaying, via the user interface, the displayed graphical representations with emphasized portions based on the first selection. The method may include, after the first selection of the first data point and in response to selection of a second data point by the user, displaying, via the user interface, the displayed graphical representations with emphasized portions based on the selection of the second data and emphasized portions based on overlap between the first selection of the first data point and the selection of the second data point. The method may include in response to a second selection of the first data point, determining, via the graphing circuitry and a subset of the one or more classifiers for each result of the semantic search results, one or more subset graphical representations, the subset of the one or more classifiers for each result of the semantic search results based on the first data point. The method may include displaying, via the graphing circuitry to the user interface, each of the one or more subset graphical representations to thereby replace and form the displayed graphical representation. The method may include in response to a first selection of a list button, displaying, via the graphing circuitry to the user interface, a tabular list based on the semantic search results corresponding to the displayed graphical representation. In another embodiment, the list button or another button in the user interface may enable a user to download the semantic search results (for example, as a spreadsheet, comma separated value file, text editing document, and/or another list or database type document, as will be understood by one skilled in the art) to a computing device corresponding to the user.

In an embodiment, the one or more graphical representations may include types of graphs comprising one or more bar graphs, pie charts, line graphs, three dimensional graphs, clusters, or other chart types. The graphing circuitry may generate clusters based on text from documents included in the semantic search results and a natural language processing algorithm. The graphing circuitry may generate a second cluster based on the second selection and a subset of the second cluster. The graphing circuitry may, in response to additional selections of one or more different data points, generate an additional set of one or more graphical representations corresponding semantic search results based on a selected one of the one or more different data points. The semantic search results or subset of the semantic search results and the displayed graphical representations may be dynamically linked. The first selection of the first data point, the second selection of the first data point, and the selection of the second data point may be received from the user interface. The user interface may comprise a graphical user interface or a web user interface displayed on a user's computing device. A plurality of graphs may be displayed as the one or more graphical representations. Each of the plurality of graphs may be based on one of the one or more classifiers for each result of the semantic search results. The one or more classifiers may include one or more of a date that a document was uploaded, an author of the document, a region associated with the author of the document, a topic of the document, a context corresponding to the document, business unit associated with the document or author of the document, a team associated with the document or author of the document, a department associated with the document or author of the document, competitors associated with the context of the document, a project number associated with the document, or keywords associated with the document.

Another embodiment of the disclosure is directed to a system for dynamic visualization of semantic search results. The system may include a search circuitry. The search circuitry may be configured to determine semantic search results based on a received search query of a set of data. The search circuitry may be configured to receive and/or access metadata or pre-extracted metadata based on the set of data and/or extract metadata based on an entire or full set of data or a portion a set of data. The search circuitry may be configured to determine one or more classifiers for each result of the semantic search results based on the metadata. The system may include a graphing circuitry. The graphing circuitry may be configured to, at a substantially same time as a determination of the one or more classifiers for each result, generate a set of one or more graphical representations of the search results based on one or more of the one or more classifiers for each result, a user input, or one or more user selections. The graphing circuitry may be configured to determine a subset of the one or more classifiers for each result of the semantic search results based on the one or more user selections. The graphing circuitry may be configured to dynamically link the subset to the set of one or more graphical representations. The system may include a display circuitry. The display circuitry may be configured to display the set of one or more graphical representations on a user interface of a remote computing device. The display circuitry may be configured to, in response to selection of a list button, display a dynamically linked subset of the one or more classifiers for each result of the semantic search results on the user interface of the remote computing device. The display circuitry may be configured to, in response to selection of a download button, prompt or initiate download of the dynamically linked subset.

In another embodiment, the one or more user selections may include selections of one or more portions of the set of one or more graphical representations. The graphing circuitry may be configured to, in response to selection of one of the one or more portions of the set of one or more graphical representations, update the set of one or more graphical representations based on the selection of one of the one or more portions of the set of one or more graphical representations. The graphing circuitry may be configured to, in response to an update to the set of one or more graphical representations, dynamically link the set of one or more graphical representations to a subset of the one or more classifiers for each result of the semantic search results based on the selection of one of the one or more portions of the set of one or more graphical representations.

One of the one or more graphical representations may be a cluster. The graphing circuitry may be configured to form the cluster via a natural language processing circuitry. The natural language processing circuitry may use text from each document in the semantic search results. The display circuitry may be configured to in response to selection of a download button, transmit a list of documents stored in the dynamically linked set of search results to the remote computing device via the user interface.

Another embodiment of the disclosure is directed to a method for generating one or more dynamic graphical representations of semantic search results. The method may include in response to reception of a search query of a set of data by a search circuitry, in substantially real-time, generating, via the search circuitry, a first set of semantic search results. The method may include receiving and/or accessing metadata or pre-extracted metadata based on the set of data and/or extracting metadata from an entire or full set of data or a portion of a set of data to thereby generate one or more classifiers, based on the metadata, for each result of the first set of semantic search results. The method may include determining, via a graphing circuitry, one or more graphical representations of the first set of semantic search results based on the one or more classifiers for each result of the first set of semantic search results. The method may include displaying, via the graphing circuitry to a user interface, each of the one or more graphical representations of the first set of semantic search results. The method may include, in response to a first selection of a first data point in the displayed graphical representations by a user, generating, via the search circuitry, a second set of sematic search results. The method may include receiving metadata based on a full or entire set of data and/or extracting metadata from each result of the second set of semantic search results to thereby generate one or more classifiers, based on the metadata, for each result of the second set of semantic search results. The method may include determining, via a graphing circuitry, one or more graphical representations of the second set of semantic search results may be based on the one or more classifiers for each result of the first set of semantic search results and the one or more classifiers for each result of the second set of semantic search results. The method may include displaying, via the graphing circuitry to a user interface, each of the one or more graphical representations of the second set of semantic search results. The method may include, in response to a first selection of a list button, displaying, via the graphing circuitry to the user interface, a tabular list based on semantic search results corresponding to currently displayed one or more graphical representations. In another embodiment, the method may include, in response to a selection of another button, prompting, via the graphing circuitry to the user interface, a user to select a location on a corresponding computing device to send the results list to and/or a format of the results list and, after selection of a location, downloading the results list to the selected location in a selected and/or default format.

In an embodiment, the one or more graphical representations of the second set of semantic search results may include emphasized portions corresponding to the first selection. The graphing circuitry may base each portion of the one or more graphical representations of the first set of semantic search results on the one or more classifiers for each result of the first set of semantic search results. Each portion may comprise a user selectable area.

Additional and/or alternative objects, features and advantages of the present disclosure will become apparent to the skilled artisan from the figures, detailed description, and examples herein. Applicant notes, however, that the figures, detailed description, and examples, while indicating certain embodiments of the instant disclosure, are provided for illustrative purposes only and are not intended to be limiting or to imply a particular limitation. Moreover, certain changes and modifications within the spirit and scope of the disclosed technology will become apparent to those of ordinary in the relevant art from this detailed description.

### BRIEF DESCRIPTION OF THE DRAWINGS

The disclosed aspects, features and advantages of the disclosure will become better understood with regard to the following descriptions, examples, claims, and accompanying drawings. Applicant notes, however, that the drawings illustrate certain embodiments of the disclosure and should not be considered limiting with regards to the breadth and scope of the disclosure:

FIG. 1 is a schematic diagram of a system for generating one or more graphical representations of search results, in accordance with certain embodiments of the present disclosure;

FIG. 2 is another schematic diagram of a system for generating one or more graphical representations of search results, in accordance with certain embodiments of the present disclosure;

FIG. 3A, FIG. 3B, FIG. 3C, FIG. 3D, FIG. 3E, and FIG. 3F are user interfaces (UIs) for displaying the one or more graphical representations of search results, in accordance with certain embodiments of the present disclosure;

FIG. 4A, FIG. 4B, and FIG. 4C are flow diagrams for generating one or more graphical representations of search results, in accordance with certain embodiments of the present disclosure; and

FIG. 5 is another flow diagram for generating one or more graphical representations of search results, in accordance with certain embodiments of the present disclosure.

### DETAILED DESCRIPTION

So that the manner in which the features and advantages of the embodiments of the systems and methods disclosed herein, as well as others that will become apparent, may be understood in more detail, a more particular description of embodiments of systems and methods briefly summarized above may be had by reference to the following detailed description of embodiments thereof, in which one or more are further illustrated in the appended drawings, which form a part of this specification. It is to be noted, however, that the drawings illustrate only various embodiments of the systems and methods disclosed herein and are therefore not to be considered limiting of the scope of the systems and methods disclosed herein as it may include other effective embodiments as well.

The following definitions are provided for clarifying certain terms and phrases of the present disclosure and are in no way intended to unnecessarily or unduly limit any embodiments and aspects related thereto.

The terms “reducing” or any variation of these terms, when used in the claims and/or specification, include any measurable decrease or complete inhibition to achieve a desired result.

The term “effective,” as used in the specification and/or claims, means adequate to accomplish a desired, expected, or intended result.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Typically, a user may submit a search request, for example, a document search request, by submitting a search query to receive a static list of search results. Numerous results, for example, such as documents and/or links to websites, may be returned in the static list of search results. In other words, many results may be returned. Thus, user's submitting the search may be provided large amounts of data. Based on such large results, some users may limit review to the first few search results, which may not provide the information sought.

The present disclosure generally relates to a system that addresses the relevant issues as described above. In particular, the system may enable substantially real-time generation and display of interactive and/or dynamic graphical representations of semantic search results for a search query, an enterprise search query, and/or a document search query of a set of data. Such a system may be configured to receive search queries of the set of data, for example, through a user interface (for example, a graphical user interface or web-based user interface), from one or more computing devices. The search queries may be submitted to a search circuitry and/or search instructions. The search circuitry and/or search instructions may produce a set of search results or semantic search results (for example, a list of documents including links to such documents, a list of websites (for example, internal and/or external). The search circuitry and/or search instructions may then receive and/or access pre-extracted metadata from a pre-processing module, circuitry, pipeline, and/or instruction based on an entire or full set of documents or other types of data to be searched (for example, the set of data or searchable data). In another embodiment, the search circuitry and/or search instructions may extract the metadata in real-time. In such an example, the search circuitry and/or search instructions may utilize a natural language processing (NLP) algorithm, instructions, or model or other algorithm or model to extract the metadata from the full set of searchable data or a subset of the data (for example, the search results). Using the extracted metadata and, in some examples a machine learning model, the search circuitry and/or search instructions may generate one or more classifiers for each result of the semantic search results. In other words, each result may include a number of specified classifiers describing and/or indicating various qualities and/or identifiers related to the search results (for example, who wrote the document, when the document was written, when the document was published, the region or country of origin, the topic or subject of the document, keywords associated with the document, among other factors).

A graphing circuitry and/or graphing instructions may determine one or more graphical representations based on the one or more classifiers for each result of the semantic search results. In embodiments, for example, the graphing circuitry may determine that, based on the one or more classifiers, that a particular graphical representation may be generated for the search results (for example, a graphical representation based on the number of documents per author, per publication year, per keyword, and/or per topic). The determined one or more graphical representations may be displayed, via a user interface (for example, a graphical user interface or a web user interface), to a user. In an embodiment, a user may choose or select which type of graphical representations to display prior to and/or after submitting a search query. The one or more graphical representations may be interactive and/or dynamic (for example, the graphing circuitry and/or graphing instructions may determine and/or generate one or more interactive and/or dynamic graphical representations). For example, a user may select any data point and/or portion of each displayed graphical representation. Upon or in response to a first selection, the graphing circuitry and/or graphing instructions may determine and/or generate one or more new graphical representations. The one or more new graphical representations may include highlighted portions of the data point and/or portion of the graphical representation selected. For example, a selected author may highlight any document in the graphical representations including that author. The user may then select the same data point and/or portion. Based on such a selection, the graphing circuitry and/or graphing instructions may generate one or more new graphical representations showing search results including the first selection and removing results lacking the first selection. In an embodiment, the user may select a different data point and/or portion and the graphing circuitry, in response, may determine one or more graphical representations with emphasized portions based on the first selection and the second selection, as well as, in some examples emphasized portions based on overlapping portions of the first selection and second selection.

In an alternative embodiment, the search circuitry and/or search instructions may be configured to, in response to a selection of a data point and/or portion of one of the one or more graphical representations, generate new semantic search results. The search circuitry and/or search instructions may receive metadata from pre-processing an entire or full set of metadata and/or may extract metadata in real-time and, based on the metadata and, in some examples, using a machine learning model, generate new one or more classifiers. The graphing circuitry and/or graphing instructions may then generate one or more new graphical representations. Thus, new search results may be formed each time a selection of a data point or portion of one of the one or more graphical representations is made. Based on this generation of new search results, each instance of one or more graphical representations may be dynamically and continuously updated.

Thus, a user may quickly digest or review the information (for example, search results and/or documents in the search results) based on the presented format (for example, one or more graphical representations). Further, the user may refine the results via one or more different selections of varying data points or portions of the one or more graphical representations. In other words, the one or more graphical representations may be interactive, allowing for selection of various data points or portions of the one or more graphical representations. Further still, the system as described may increase user productivity and allow users to locate relevant documents and/or other results in a shorter than typical amount of time.

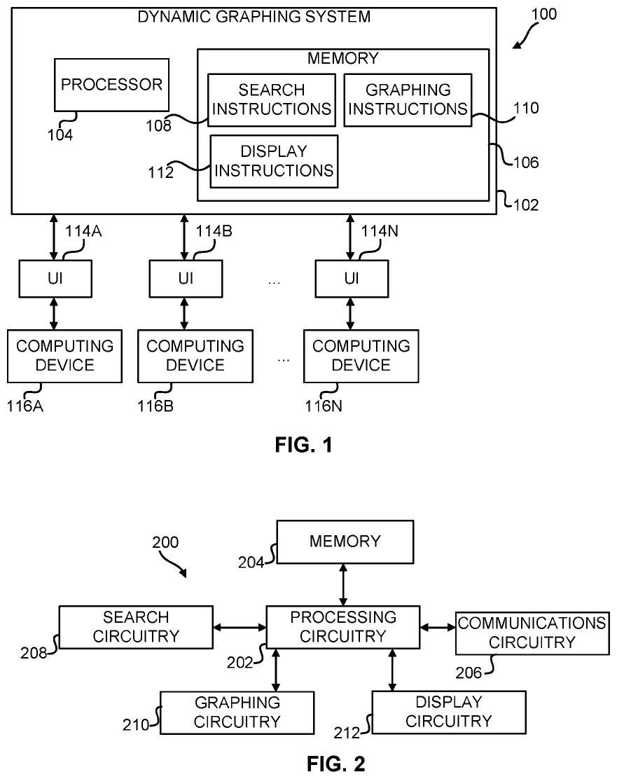

FIG. 1 is a schematic diagram of a system for generating one or more graphical representations of search results, in accordance with certain embodiments of the present disclosure. The system 100 may include a dynamic graphing system 102. The dynamic graphing system 102 may include a one or more processors 104 and memory 106. The memory 106 may include and/or store instructions and/or models executable by the one or more processors 104. The memory 106 may include search instructions 108, graphing instructions 110, and display instructions 112.

The search instructions 108 or display instructions 112 may, when executed by the one or more processors 104, generate a user interface (UI) 114A, 114B, up to 114N including a search box configured to receive search queries for a set of data from one or more computing devices 116A, 116B, up to 116N. The search instructions 108 may, when a search query is submitted by one of the computing devices 116A, 116B, up to 116N via a corresponding UI 114A, 114B, up to 114N, generate search results or semantic search results based on the search query. The search results may include a plurality of documents (for example, in a document search), a list of websites, and/or other results. The search instructions 108 may then extract metadata, in real-time, from each of the search results or semantic search results (for example, from each document and/or from each website). For example, the search instructions 108 may utilize an NLP algorithm to generate or produce the metadata. In another embodiment, the metadata may be pre-extracted, based on the full set of searchable data (for example, the documents in the search and/or other data, such as websites) and using pre-processing instructions, and the search instructions 108 may receive and/or access the pre-extracted metadata in addition to or rather than extracting data rea-time. The search instructions 108 may then generate one or more classifiers based on the metadata for each result of the search results or semantic search results. In such embodiments, the search instructions 108 may include a machine learning model configured to generate the one or more classifiers. The metadata and/or one or more classifiers may be stored in memory 106 along with each result. Further, metadata and/or the one or more classifiers corresponding to a result may include an indicator to indicate which result corresponds to that particular metadata and/or the one or more classifiers. The search instructions 108 may perform similar operations in response to a reception of a selection of a data point or portion of a graphical representation. For example, if a user selects a data point or portion of a graphical representation, then the search instructions 108 may generate another set of search results or semantic search results based on the original search query and the data point or portion of the graphical representation selected. The search instructions 108 may extract metadata from the other set of search results or semantic search results and/or receive or access corresponding pre-extracted metadata. The search instructions 108 may generate one or more classifiers based on the extracted and/or pre-extracted metadata. The one or more classifiers may include one or more of a date that a document was uploaded, an author of the document, a region associated with the author of the document, a topic of the document, a context corresponding to the document, business unit associated with the document or author of the document, a team associated with the document or author of the document, a department associated with the document or author of the document, competitors associated with the context of the document, a project number associated with the document, keywords associated with the document, and/or other factors based on the content of and/or metadata associated with each document.

The graphing instructions 110 may, when executed by the one or more processors 104, determine one or more graphical representations or set of one or more graphical representations of the search results or semantic search results based on the one or more classifiers for each result of the search results or semantic search results. The graphing instructions 110 may determine the type of graphical representations to generate based on various factors. For example, the graphing instructions 110 may determine the type of graphical representations based on a user selected display setting, the generated classifiers, and/or other factors. Once one or more types of graphical representations are determined, the graphing instructions 110 may generate the one or more graphical representations or set of one or more graphical representations. The type of graphical representations may include one or more bar graphs, pie charts, line graphs, three dimensional graphs, clusters, or other chart types. In such examples, the cluster chart may be generated based on an NLP algorithm, instructions, or model. The NLP algorithm, instructions, or model may be included in the memory 106 or other storage device included in or in communication with the dynamic graphing system 102. Such a cluster may be generated upon user request or user response. In another example, the cluster chart may be generated automatically. In another example, the graphing instructions 110 may utilize the NLP algorithm, instructions, or model and the one or more classifiers, the extracted and/or pre-extracted metadata, a portion of text from a document associated with each search result, and/or the full text from the document associated with each search result to generate the cluster.

The graphing instructions 110 may, when executed, be configured to generate interactive and dynamic graphical representations. The graphing instructions 110, when determining or generating the one or more graphical representations, may configure the one or more graphical representations to include selectable data points and/or portions of the actual graphical representations. For example, each bar in a bar graph may be selectable, each portion of a pie chart may be selectable, and so on. Once a user selects a data point or a portion of the one or more graphical representations, the graphing instructions 110 may perform different actions. In an embodiment, the graphing instructions 110 may emphasize or highlight the portions of the one or more graphical representations corresponding to the data point or portion selected. If a user selects the same data point or portion again, the graphing instructions 110 may generate a new set of one or more graphical representations based on the data point or portion selected. If the user selects a second data point or portion, the graphing instructions 110 may emphasize the second data point or portion, in addition to emphasizing the first data point or portion in the one or more graphical representations. Overlapping portions in the one or more graphical representations may be emphasized to indicate that such an overlapping portion includes the first data point or portion and the second data point or portion. In another embodiment, the graphing instructions 110 may, in response to a first selection and then a second selection of a data point or portion of a graphical representation, generate new one or more graphical representations based on data point or portion of the graphical representation. In such an example, the new one or more graphical representations may be a subset of the graphical representations.

In an embodiment, the graphing instructions 110 may dynamically link corresponding search results to currently displayed one or more graphical representations. For example, if the user selects a first data point or portion of the one or more graphical representations such that one or more new graphical representations are generated, then the graphing instructions 110 may link the corresponding search results or subset of the search results (for example, documents and/or website links) to the one or more new graphical representations. Thus, if the user selects the list button or download button, corresponding search results (for example, a subset of the search results) are displayed or downloaded to a user's computing device based on the one or more new graphical representations.

In an embodiment, the search instructions 108 and graphing instructions 110 may perform the functions described herein in real-time or substantially real-time. The search instructions 108 and/or graphing instructions 110 may perform the functions for a plurality of computing devices (for example, computing device 116A, 116B, or up to 116N) simultaneously or substantially simultaneously and continuously. For example, as the one or more classifiers are determined or generated, the system 100 may, at substantially the same time, generate a set of one or more graphical representations of search results based on the one or more classifiers. The system 100 may link any subset of search results to updated graphical representations upon selection of a data point.

The display instructions 112 may, in response to determination of one or more graphical representations, display the one or more graphical representations at the corresponding UI (for example, the UI 114A, 114B, or up to 114N corresponding to the computing device 116A, 116B, or up to 116N that initiated the search query and/or selects a data point or portion of one or more graphical representations).

In an embodiment, the search query may be an internal search query. An internal search query may be a search performed on a website or GUI internal to an organization or enterprise. Results from such examples may include internal and/or private documents and/or other results. In another embodiment, the system 100 may include searches via the internet thereby providing access to public documents and/or other results.

In some examples, the dynamic graphing system 102 may be a computing device. The term “computing device” is used herein to refer to any one or all of programmable logic controllers (PLCs), programmable automation controllers (PACs), industrial computers, servers, virtual computing device or environment, desktop computers, personal data assistants (PDAs), laptop computers, tablet computers, smart books, palm-top computers, personal computers, smartphones, virtual computing devices, cloud based computing devices, and similar electronic devices equipped with at least a processor and any other physical components necessarily to perform the various operations described herein. Devices such as smartphones, laptop computers, and tablet computers are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (for example, an application) hosted by a computing device that causes the computing device to operate as a server. A server module (for example, server application) may be a full function server module, or a light or secondary server module (for example, light or secondary server application) that is configured to provide synchronization services among the dynamic databases on computing devices. A light server or secondary server may be a slimmed-down version of server type functionality that can be implemented on a computing device, such as a smart phone, thereby enabling it to function as an Internet server (for example, an enterprise e-mail server) only to the extent necessary to provide the functionality described herein.

As used herein, a “non-transitory machine-readable storage medium” or “memory” may be any electronic, magnetic, optical, or other physical storage apparatus to contain or store information such as executable instructions, data, and the like. For example, any machine-readable storage medium described herein may be any of random access memory (RAM), volatile memory, non-volatile memory, flash memory, a storage drive (for example, hard drive), a solid state drive, any type of storage disc, and the like, or a combination thereof. The memory may store or include instructions executable by the processor.

As used herein, a “processor” or “processing circuitry” may include, for example one processor or multiple processors included in a single device or distributed across multiple computing devices. The processor (for example, processor 102 shown in FIG. 1) may be at least one of a central processing unit (CPU), a semiconductor-based microprocessor, a graphics processing unit (GPU), a field-programmable gate array (FPGA) to retrieve and execute instructions, a real time processor (RTP), other electronic circuitry suitable for the retrieval and execution instructions stored on a machine-readable storage medium, or a combination thereof.

In an embodiment, the machine learning model or classifier (for example, NLP algorithm, instructions, or model) may be a supervised or unsupervised learning model. In an embodiment, the machine learning model or classifier may be based on one or more of decision trees, random forest models, random forests utilizing bagging or boosting (as in, gradient boosting), neural network methods, support vector machines (SVM), other supervised learning models, other semi-supervised learning models, other unsupervised learning models, or some combination thereof, as will be readily understood by one having ordinary skill in the art. In an embodiment, the NLP algorithm, instructions, or model may generate a cluster chart.

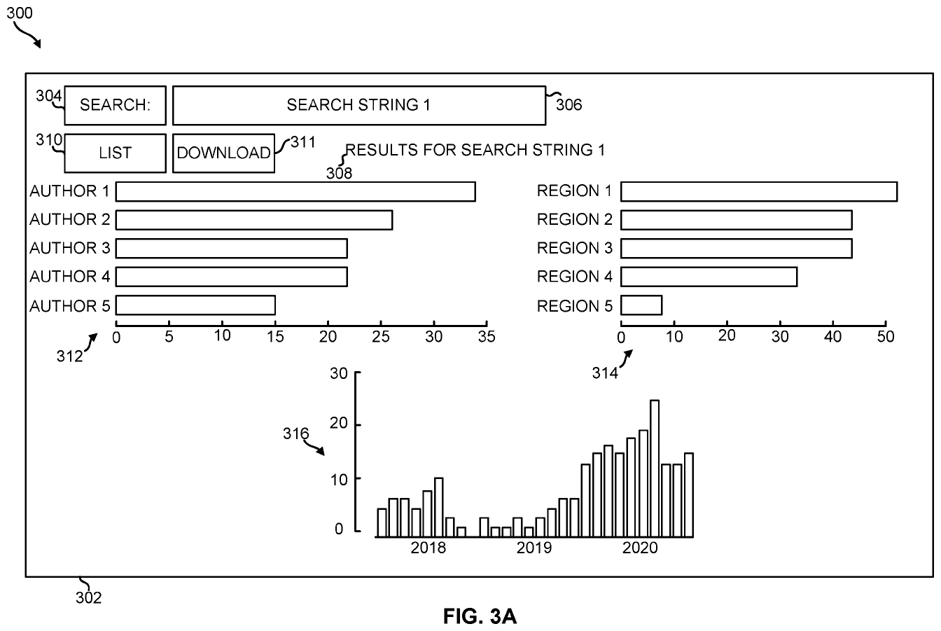

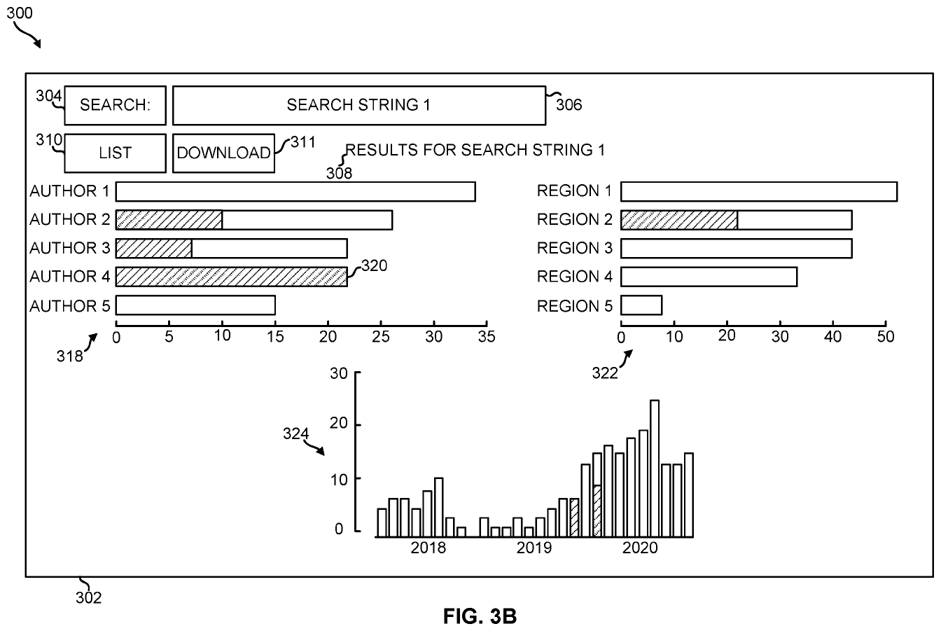

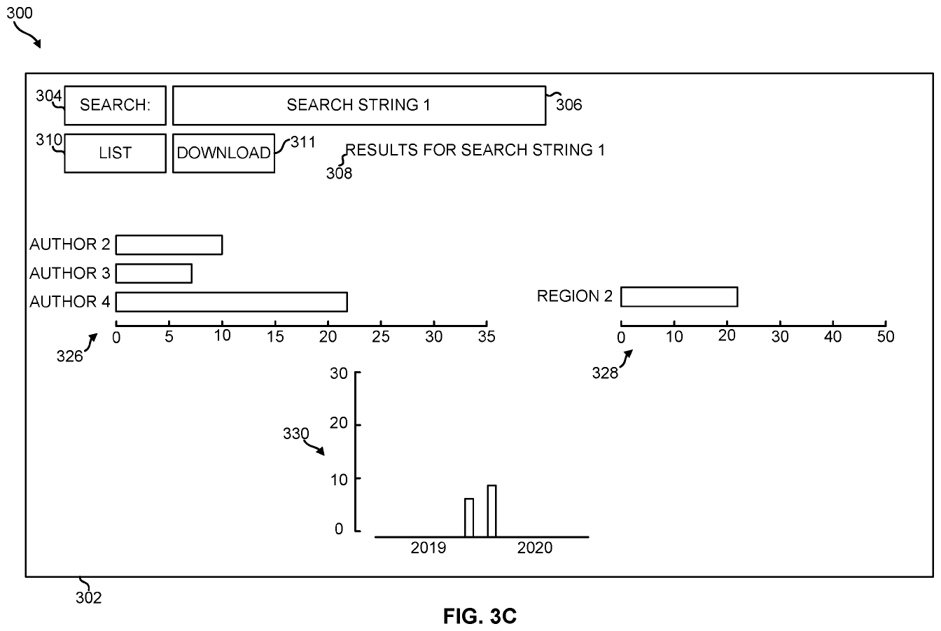

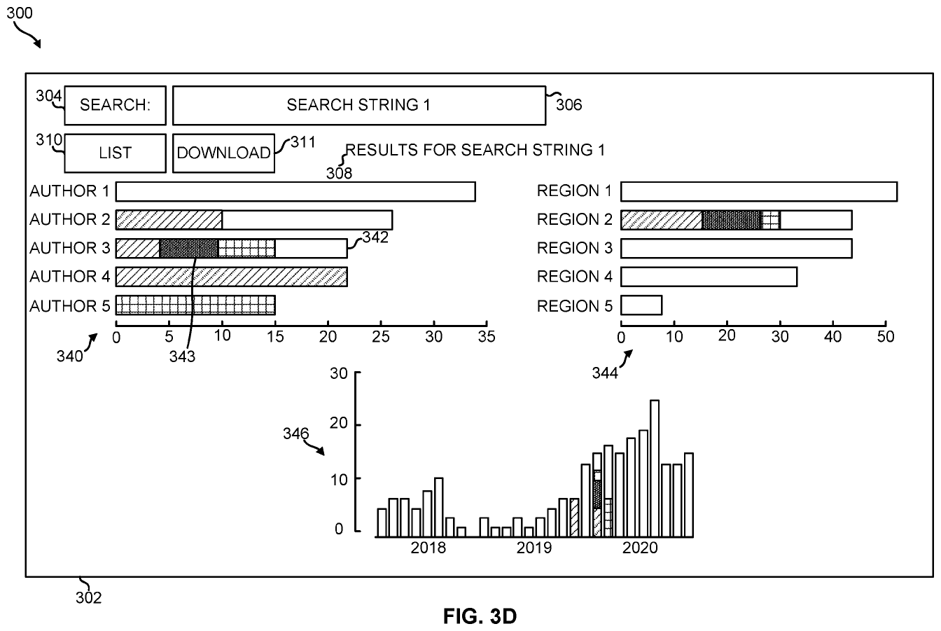

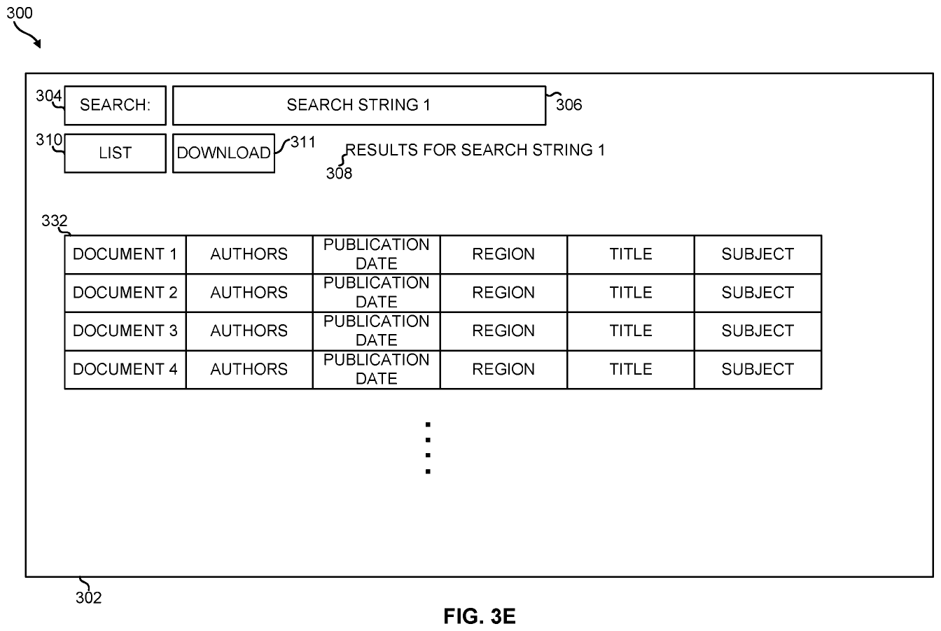

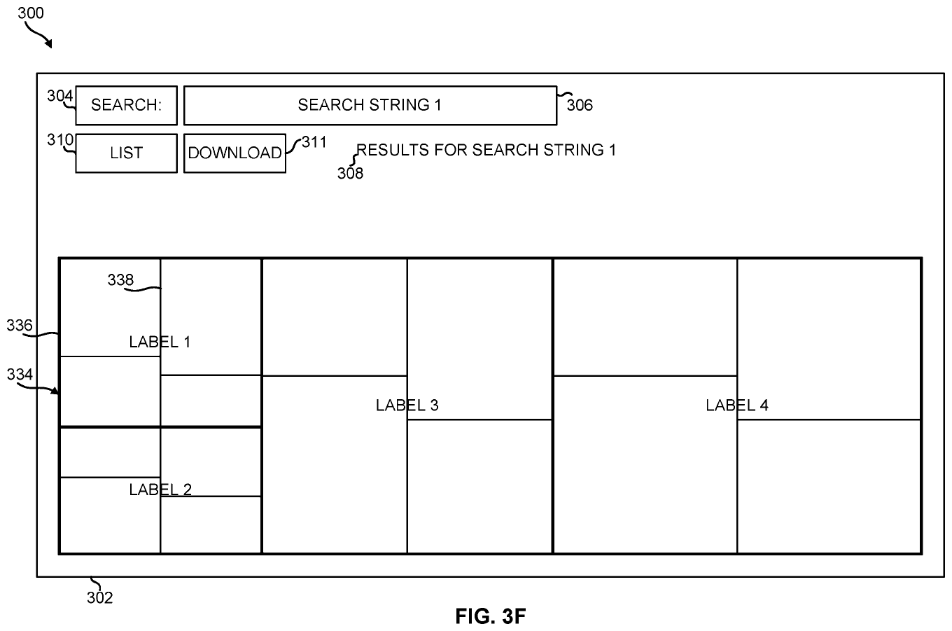

FIG. 2 is another schematic diagram of a system for generating one or more graphical representations of search results, in accordance with certain embodiments of the present disclosure. The apparatus 200 may include processing circuitry 202, memory 204, communications circuitry 206, search circuitry 208, graphing circuitry 210, and display circuitry 212, each of which will be described in greater detail below. While the various components are only illustrated in FIG. 2 as being connected with processing circuitry 202, it will be understood that the apparatus 200 may further comprise a bus (not expressly shown in FIG. 2) for passing information amongst any combination of the various components of the apparatus 200. The apparatus 200 may be configured to execute various operations described herein, such as those described above in connection with FIG. 1 and below in connection with FIGS. 3A-5.

The processing circuitry 202 (and/or co-processor or any other processor assisting or otherwise associated with the processor) may be in communication with the memory 204 via a bus for passing information amongst components of the apparatus. The process circuitry 202 may be embodied in a number of different ways and may, for example, include one or more processing devices configured to perform independently. Furthermore, the processor may include one or more processors configured in tandem via a bus to enable independent execution of software instructions, pipelining, and/or multithreading.

The processing circuitry 202 may be configured to execute software instructions stored in the memory 204 or otherwise accessible to the processing circuitry 202 (for example, software instructions stored on a separate storage device). In some cases, the processing circuitry 202 may be configured to execute hard-coded functionality. As such, whether configured by hardware or software methods, or by a combination of hardware with software, the processing circuitry 202 represents an entity (for example, physically embodied in circuitry) capable of performing operations according to various embodiments of the present disclosure while configured accordingly. Alternatively, as another example, when the processing circuitry 202 is embodied as an executor of software instructions, the software instructions may specifically configure the processing circuitry 202 to perform the algorithms and/or operations described herein when the software instructions are executed.

Memory 204 is non-transitory and may include, for example, one or more volatile and/or non-volatile memories. In other words, for example, the memory 204 may be an electronic storage device (for example, a computer readable storage medium). The memory 204 may be configured to store information, data, content, applications, software instructions, or the like, for enabling the apparatus 200 to carry out various functions in accordance with example embodiments contemplated herein.

The communications circuitry 206 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 206 may include, for example, a network interface for enabling communications with a wired or wireless communication network. For example, the communications circuitry 206 may include one or more network interface cards, antennas, buses, switches, routers, modems, and supporting hardware and/or software, or any other device suitable for enabling communications via a network. Furthermore, the communications circuitry 206 may include the processing circuitry for causing transmission of such signals to a network or for handling receipt of signals received from a network. The communications circuitry 206, for example, may receive search queries and/or transmit results and corresponding one or more graphical representations from and/or to a user interface associated with a computing device.

The apparatus 200 may include search circuitry 208 configured to receive (for example, via communications circuitry 206) search queries, determine search results, extract metadata from the search results, receive and/or access pre-extracted metadata, and/or generate one or more classifiers based on the extracted and/or pre-extracted metadata (for example, using, for example, a machine learning model). The search circuitry 208 may be configured to generate additional search results based on a user's selection of a data point or portion of one of the one or more graphical representations. The search circuitry 208 may utilize processing circuitry 202, memory 204, or any other hardware component included in the apparatus 200 to perform these operations, as described in connection with FIGS. 3-7B below. The search circuitry 208 may further utilize communications circuitry 206 to gather data from a variety of sources. The output of the search circuitry 208 may be transmitted to other circuitry of the apparatus 200 (for example, graphing circuitry 210).

In addition, the apparatus 200 further comprises graphing circuitry 210 that may determine types of one or more graphical representations, determine the one or more graphical representations, and dynamically link each search result to the one or more graphical representation. The graphing circuitry 210 may further utilize communications circuitry 206 to gather data (for example, search results) from a variety of sources (for example, search circuitry 208 or computing device 118A, 118B, 118N) and in some embodiments may utilize processing circuitry 202 and/or memory 204 to determine the one or more graphical representations. The output of the graphing circuitry 210 may be transmitted to other circuitry of the apparatus 200.

In addition, the apparatus 200 further comprises display circuitry 212 that may display the one or more graphical representations and/or a tabular list of search results. The display circuitry 212 may further utilize communications circuitry 206 to gather data (for example, one or more graphical representations) from a variety of sources (for example, graphing circuitry 210) and in some embodiments may utilize processing circuitry 202 and/or memory 204 to display the one or more graphical representations.

Although components 202-212 are described in part using functional language, it will be understood that the particular implementations necessarily include the use of particular hardware. It should also be understood that certain of these components 202-212 may include similar or common hardware. For example, the search circuitry 208, graphing circuitry 210, and display circuitry 212 may each at times leverage use of the processing circuitry 202, memory 204, or communications circuitry 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry,” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the search circuitry 208, graphing circuitry 210, and display circuitry 212 may leverage processing circuitry 202, memory 204, or communications circuitry 206 as described above, it will be understood that any of these elements of apparatus 200 may include one or more dedicated processors, specially configured field programmable gate arrays (FPGA), or application specific interface circuits (ASIC) to perform its corresponding functions, and may accordingly leverage processor 202 executing software stored in a memory or memory 204, communications circuitry 206 for enabling any functions not performed by special-purpose hardware elements. In all embodiments, however, it will be understood that the search circuitry 208, graphing circuitry 210, and display circuitry 212 are implemented via particular machinery designed for performing the functions described herein in connection with such elements of apparatus 200.

In some embodiments, various components of the apparatus 200 may be hosted remotely (for example, by one or more cloud servers) and thus need not physically reside on the corresponding apparatus 200. Thus, some or all of the functionality described herein may be provided by third party circuitry. For example, a given apparatus 200 may access one or more third party circuitries via any sort of networked connection that facilitates transmission of data and electronic information between the apparatus 200 and the third party circuitries. In turn, that apparatus 200 may be in remote communication with one or more of the other components describe above as comprising the apparatus 200.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (for example, memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

FIG. 3A, FIG. 3B, FIG. 3C, FIG. 3D, FIG. 3E, and FIG. 3F is user interface (UI) for displaying the one or more graphical representations of search results, in accordance with certain embodiments of the present disclosure. Turning to FIG. 3A, a user may input a search string (for example, search string 1) in a search box 306. Upon entry of a search string into the search box 306, the user may select the search button 304. In response to selection of the search button 304, a system or apparatus (for example, system 100 or apparatus 200) may determine a set of semantic search results as described herein. The system or apparatus may then extract metadata and/or receive and/or access pre-extracted metadata, as described herein. The system or apparatus may utilize the extracted and/or pre-extracted metadata to generate the one or more graphical representations. Such graphical representations may include various types of charts, including, but not limited to, a bar chart, a line chart, a pie chart, a cluster, a three dimensional graph, among others. Each chart may be based on one or more classifiers, for example, chart 312 may be based on authors for each document or search result, chart 314 may be based on a region in which each document was published or drafted or the region associated with the author, and chart 316 may be based on publication year. Other classifiers may be considered, such as topic, keywords, and other factors. Each chart may be displayed in the UI 302. Each chart under the results for search string 1 308 may include selectable or interactive portions.

FIG. 3B illustrates one or more graphical representations subsequent to a user selection a data point or portion of a graphical representation. In an embodiment, a user may select, for example, author 4 or any other author, region, date, or other classifier included in a graphical representation. Subsequent to a user selection of author 4 (for example, selecting the label and/or bar representing the number of documents authored by the author), the system or apparatus may update the displayed or currently displayed one or more graphical representations. For example, if author 4 is selected, the system or apparatus may update the displayed or currently displayed one or more graphical representations such that documents including the selected author (for example, author 4) are emphasized or highlighted (for example, see bar 320). Thus, the region the author drafted, published, posted internally, or otherwise made available the document or the region associated with the author may be highlighted. As illustrated in FIG. 3B, chart 318 may include several highlighted and/or emphasized authors (for example, the selected author and co-authors), chart 322 may include highlighted and/or emphasized regions, and chart 324 may include several highlighted and/or emphasized dates. Other charts utilizing other classifiers may include similar highlights and/or emphasis.

FIG. 3C illustrates one or more graphical representations subsequent to a second user selection of the same data point or portion of the graphical representation. In an embodiment, a user may select the same data point or portion of the graphical representation more than once or at least twice. Upon a second or other subsequent selection of the same data point, the system or apparatus may update the displayed or currently displayed one or more graphical representations. The updated one or more graphical representations may include the data corresponding to the user selection. In other words, rather than including highlighted and/or emphasized portions of each chart, the charts may include the data corresponding to the selection. For example, chart 326 may include the selected author and/or co-authors; chart 328 may include the region the author drafted, published, posted internally, and/or otherwise made available the document; and chart 330 may include the dates the author drafted, published, posted internally, uploaded, and/or otherwise made available the document. In a further embodiment, the system or apparatus may determine or generate the charts after further determination of search results, metadata extraction, and/or after access or reception of pre-extracted metadata. In another embodiment, the system or apparatus may utilize a subset of the search results and extracted metadata. In yet another embodiment, selection of the list button 310 may display the subset of the search results (for example, search results corresponding to the user selection).

In another embodiment, the system or apparatus, in response to selection of the download button 311, may prompt a user to select a format and/or location to store or download the subset of search results and/or the graphical representations to. The user may select a format comprising one or more of a spreadsheet, comma separated value file, text editing document, and/or another list or database type document, as will be understood by one skilled in the art. The user may select a location in memory of the user's corresponding computing device. Upon selection of a location, the system or apparatus may initiate a download of the subset of search results and/or the graphical representations in the selected format or a default format. Further, the user may specify the type of results to download, such as a list, the actual documents (for example, downloaded as files or as a compressed file), and/or the graphical representations.

FIG. 3D illustrates one or more graphical representations subsequent to a first user selection of a first and a second data point or portion of the graphical representation. In an embodiment, a user may select a first data point or portion of the graphical representation (for example, author 4) and then select a second data point or portion of the graphical representation (for example, author 5). In such an embodiment, subsequent to the second selection, the one or more graphical representations may be further updated to highlight or emphasize the second selected data point or portion of the graphical representations. Further, overlapping portions of the first selection and the second selection may be highlighted and/or emphasized such that the overlapping portion (for example, documents or other search results including the first selection and the second selection) is differentiated from the first selection and second selection (for example, see overlapping portion 343). In another embodiment, the system or apparatus, in response to a further selection of the first selection and/or second selection, may update the one or more graphical representations such that data not including the first selection and second selection is removed. As illustrated in FIG. 3D, the chart 340 may highlight and/or emphasize authors and/or co-authors including the first selection and second selection (for example, author 4 and author 5), chart 344 may highlight and/or emphasize the region corresponding to the first selection and second selection, and chart 346 may highlight and/or emphasize dates corresponding to the first selection and second selection.

FIG. 3E illustrates a list of search results subsequent to a user selection of the list button 310. In an embodiment, a user may select the list button 310 at any time. The search results displayed 332 upon selection of the list button 310 may be based on the currently displayed one or more graphical representations. Further, the system or apparatus may, in response to selection of the list button 310, when one or more data points and/or portions of the graphical representations include highlighted and/or emphasized portions, the search results displayed 332 may include similarly highlighted and/or emphasized portions or may include an indicator indicative of the user selection (for example, such as a number, a text-based identifier, or other identifiers). In another embodiment, the search results displayed 332 may be sorted based on the user selection.

FIG. 3F illustrates a cluster 334 formed based on the search results and/or user selection. In an embodiment, one of the one or more graphical representations may be a cluster 334. An NLP algorithm or model (for example, included in the system or apparatus) may form, generate, or determine the cluster 334 based on the text included in a document or at website. The cluster 334 may include one or more different sections (for example, such as section 336). Each section may include a higher-level label (for example, label 1) and one or more sub-labels (for example, such as sub-label 338). For example, the label may be a high level keyword describing one or more of the search results or documents. The sub-label may further distinguish or describe the documents classified by the labels. The labels may include a topic, a keyword or keywords, a phrase, context corresponding to the documents, business unit associated with the document or author of the document, a team associated with the document or author of the document, a department associated with the document or author of the document, competitors associated with the context of the document, a project number associated with the document, and/or other factors. In such examples, the cluster 334 may be included with other one or more graphical representations. Further, the cluster 334 may be dynamic and interactive. In other words, a user may select one or more different classifiers and/or sub-classifiers. Further still, user selections may be highlighted and/or emphasized, similar to highlighting and/or emphasis of portions of other charts as described herein.

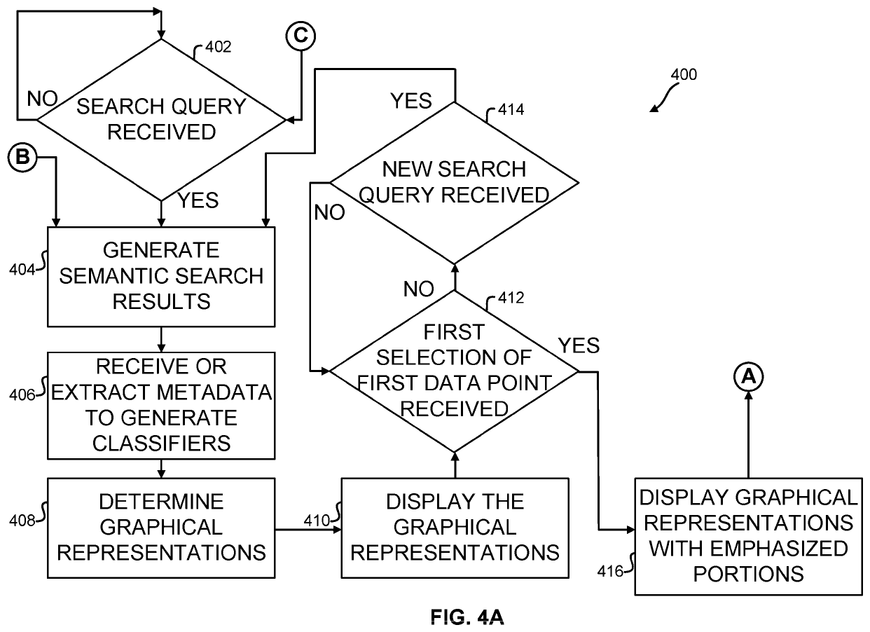

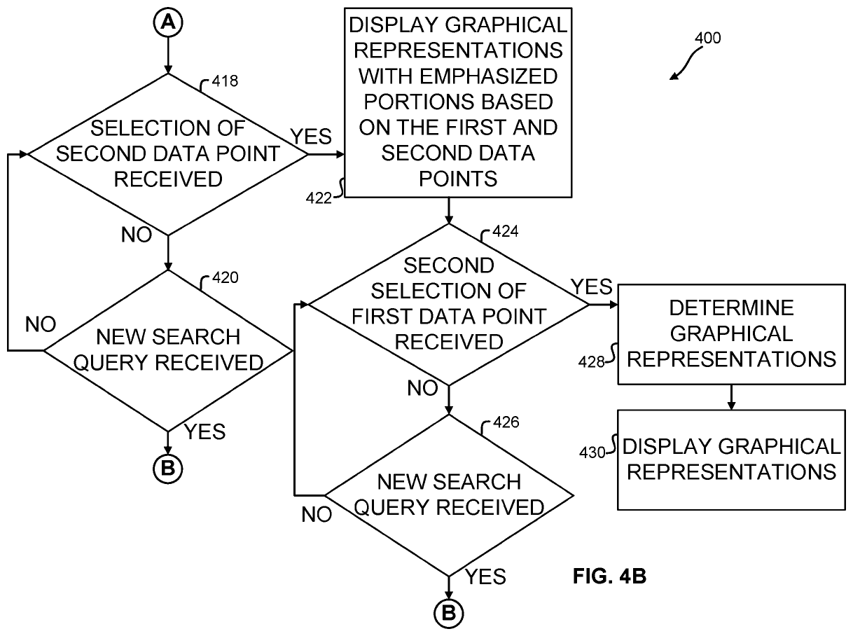

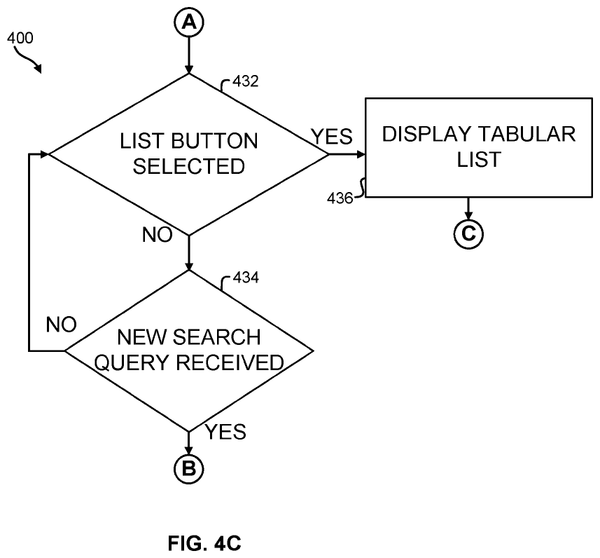

FIG. 4A, FIG. 4B, and FIG. 4C are flow diagrams for generating one or more graphical representations of search results, in accordance with certain embodiments of the present disclosure. Unless otherwise specified, the actions of method 400 may be completed within system 100 and/or apparatus 200. Specifically, method 400 may be included in one or more programs, protocols, or instructions loaded into the memory 106 of the dynamic graphic system 102 and executed on the processor 104 or one or more processors. The order in which the operations are described is not intended to be construed as a limitation, and any number of the described blocks may be combined in any order and/or in parallel to implement the methods

At block 402, the system or apparatus may determine whether a search query has been received. Such an indication may be determined based on selection of a search button and/or entry of a search query. The system or apparatus may receive an indication of submission of the search query, in addition to reception of the actual search query, based on such inputs. At block 404, the system or apparatus may generate search results or semantic search results in response to reception of the search query. In an example, the system or apparatus may utilize one or more algorithms and/or models to find documents, links to websites, and/or other information. The algorithms and/or models may analyze, for example via noun chunks and/or NLP, the search query and based on such analyze generate a list of search results. In an embodiment, the search results may include one or more documents internal to an enterprise (for example, available via an enterprise's intranet) or external to the enterprise (for example, available via the internet). In a further embodiment, the one or more documents included in the search results that are internal to the enterprise may be further based on the user submitting the search query (for example, search results may be based on user access to particular documents in an enterprise or organization).

At block 406, the system or apparatus may extract metadata from each of the search results. The system or apparatus may extract the metadata, in real-time or substantially real-time, via an algorithm and/or model, such as an NLP algorithm or model. In another embodiment, the system or apparatus may receive or access pre-extracted metadata from a storage location (for example, a memory or database). Further, the system or apparatus may determine or generate, based on the extracted and/or pre-extracted metadata, one or more classifiers. In an embodiment, a machine learning model may generate the one or more classifiers. The one or more classifiers may include the author of a document, the date a document is published or posted to an internal location, the region the document derived from, keywords associated with the documents, topics associated with the documents, and/or other factors corresponding to the documents. At block 408, the system or apparatus may determine graphical representations based on the one or more determined or generated classifiers. In an embodiment, one or more of one or more potential graphical representations may be initially generated or generated by default. A user may select the one or more graphical representations to display at any time. Subsequent to such a selection, the system or apparatus may initially generate the selected one or more graphical representations. In another embodiment, the system or apparatus may generate the one or more graphical representations based on the one or more classifiers. Further, a user may deselect any of the one or more graphical representations to remove the one or more graphical representations from the corresponding UI. In another embodiment, the system or apparatus may link the one or more graphical representations to the search results. In other words, as the one or more graphical representations are adjusted (for example, based on user selection), then the system or apparatus may automatically reduce the list of search results (for example, determine a subset of the set of search results). At block 410, the system or apparatus may display the one or more graphical representations on the corresponding user's UI.

At block 412, the system or apparatus may determine whether a first selection of a first data point or portion of one of the one or more graphical representations has been received. In other words, the system or apparatus may determine whether a user has submitted a first selection. At block 414, if a selection has not been received, then the system or apparatus may determine whether a new search query has been received or submitted. If a new search query has been received, then the system or apparatus may determine a new set of search results and determine one or more new graphical representations.

At block 416, the system or apparatus may, in response to reception of the first selection of the first data point or portion of the one or more graphical representations, display one or more graphical representations with corresponding emphasized portions. In an embodiment, the system or apparatus may determine and/or generate the one or more new graphical representations in response to the reception of the first selection and then display the one or more new graphical representations. At block 418, the system or apparatus may determine whether a second data point or portion of the one or more graphical representations has been received or submitted. If no second selection has been received, then the system or apparatus may determine if a search query has been submitted at block 420. If a second selection has been received, then, at block 422, the system may display one or more graphical representation with the first and second data points or portions of the one or more graphical representations emphasized. Further, the system or apparatus may emphasize the overlapping portions of the first data point and the second point.

At block 424, the system or apparatus may determine whether a second selection of the first data point and/or second data point has been received or submitted. If no second selection has been received or submitted, at block 426 the system or apparatus may determine if a new search query has been received or submitted. At block 428, the system or apparatus may determine one or more new graphical representations based on the second selection of the first data point and/or second data point. At block 430, the system or apparatus may display the determined or generated one or more graphical representations. In an embodiment, the system or apparatus may perform similar functions for further selections of different or the same data points. In other words, a user may select a plurality of different data points to generate a display with multiple portions of the one or more graphical representations including highlighted and/or emphasized portions.

At block 432, the system or apparatus may determine whether the list button has been selected. If the list button has not been selected, at block 434 the system or apparatus may determine whether a new search query has been received or submitted. If the list button has been selected, at block 436, the system or apparatus may display a tabular list corresponding to currently displayed one or more graphical representations. As noted, the blocks described in method 400 may be performed in parallel. For example, the system and apparatus may substantially continuously determine whether the list button has been selected or whether any of the data points in the one or more graphical representations has been selected. Further, the system or apparatus may substantially continuously determine whether a new search query has been submitted. In another embodiment, a download button may be selected. In response to such a selection, the system or apparatus may prompt or initiate download of the tabular list and/or graphical representations.

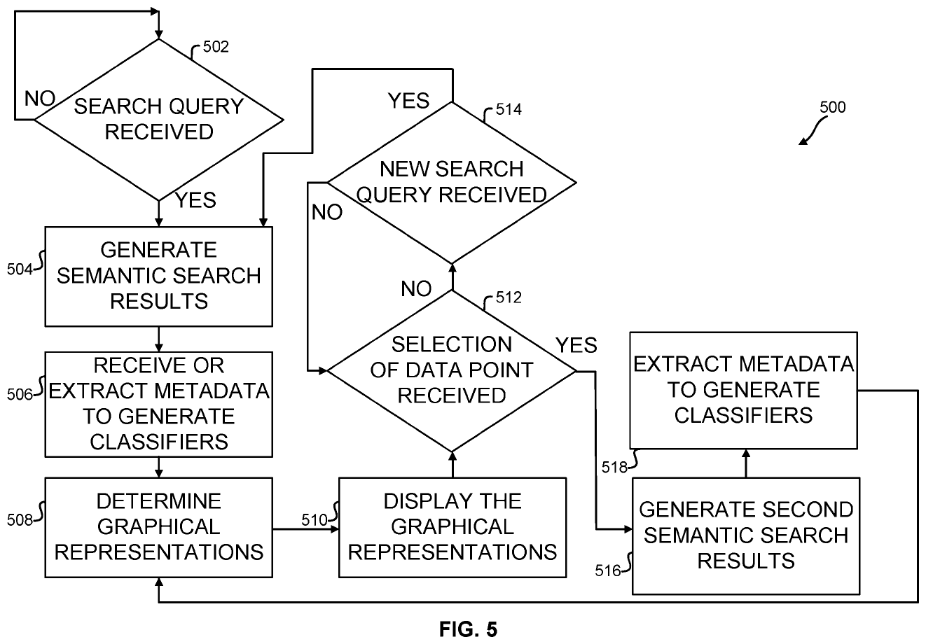

FIG. 5 is another flow diagram for generating one or more graphical representations of search results, in accordance with certain embodiments of the present disclosure. Unless otherwise specified, the actions of method 500 may be completed within system 100 and/or apparatus 200. Specifically, method 500 may be included in one or more programs, protocols, or instructions loaded into the memory 106 of the dynamic graphing system 102 and executed on the processor or one or more processors 104. The order in which the operations are described is not intended to be construed as a limitation, and any number of the described blocks may be combined in any order and/or in parallel to implement the methods

At block 502, the system or apparatus may determine whether a search query has been received. Such an indication may be determined based on selection of a search button and/or entry of a search query. The system or apparatus may receive an indication of submission of the search query, in addition to reception of the actual search query, based on such inputs. At block 504, the system or apparatus may generate search results or semantic search results in response to reception of the search query. In an example, the system or apparatus may utilize one or more algorithms and/or models to find documents, links to websites, and/or other information. The algorithms and/or models may analyze, for example via noun chunks and/or NLP, the search query and based on such analyze generate a list of search results. In an embodiment, the search results may include one or more documents internal to an enterprise (for example, available via an enterprise's intranet) or external to the enterprise (for example, available via the internet). In a further embodiment, the one or more documents included in the search results that are internal to the enterprise may be further based on the user submitting the search query (for example, search results may be based on user access to particular documents in an enterprise or organization).

At block 506, the system or apparatus may extract metadata from each of the search results. The system or apparatus may extract the metadata in real-time or substantially real-time, via an algorithm and/or model, such as an NLP algorithm or model. In another embodiment, the system or apparatus may receive or access pre-extracted metadata from a storage location (for example, a memory or database). Further, the system or apparatus may determine or generate, based on the extracted and/or pre-extracted metadata, one or more classifiers. In an embodiment, a machine learning model may generate the one or more classifiers. The one or more classifiers may include the author of a document, the date a document is published or posted to an internal location, the region the document derived from, keywords associated with the documents, topics associated with the documents, and/or other factors corresponding to the documents. At block 408, the system or apparatus may determine graphical representations based on the one or more determined or generated classifiers. In an embodiment, one or more of one or more potential graphical representations may be initially generated or generated by default. A user may select the one or more graphical representations to display at any time. Subsequent to such a selection, the system or apparatus may initially generate the selected one or more graphical representations. In another embodiment, the system or apparatus may generate the one or more graphical representations based on the one or more classifiers. Further, a user may deselect any of the one or more graphical representations to remove the one or more graphical representations from the corresponding UI. In another embodiment, the system or apparatus may link the one or more graphical representations to the search results. In other words, as the one or more graphical representations are adjusted (for example, based on user selection), then the system or apparatus may automatically reduce the list of search results (for example, determine a subset of the set of search results). At block 510, the system or apparatus may display the one or more graphical representations on the corresponding user's UI.

At block 512, the system or apparatus may determine whether a selection of a data point or a portion of the one or more graphical representations is received or submitted. If no selection has been received or submitted, at bock 514 the system or apparatus may determine whether a new search query has been received or submitted. If a selection of a data point or portion of the one or more graphical representations has been received, at block 516 the system or apparatus may determine or generate second or subsequent search results or semantic search results. At block 518, the system or apparatus may extract the metadata from each search result and/or receive and/or access pre-extracted metadata to generate one or more new classifiers. At block 508, the system or apparatus may determine one or more new graphical representations based on the one or more new classifiers. At block 510, the system or apparatus may display the one or more new graphical representations.

While particular terms and concepts are incorporated in the present disclosure, Applicant notes that the disclosed terms and concepts are exclusively utilized in a descriptive capacity and should not therefore be construed or interpreted as limiting in any way. Certain embodiments and aspects of the disclosed systems, processes and methods have been described in detail with particular reference to the illustrated embodiments. However, it will be apparent that numerous and various modifications and alterations may be made within the spirit and scope of the embodiments of systems, processes and methods described herein, and such modifications and changes are to be considered equivalents and within the breadth and scope of the disclosure.

What is claimed is:

1. A method for generating one or more dynamic graphical representations of semantic search results, the method comprising:
in response to reception of a search query by a search circuitry, in substantially real-time:
generating, via the search circuitry, semantic search results of a set of data,
receiving pre-extracted metadata based on the set of data to thereby generate one or more classifiers, based on the metadata, for each result of the semantic search results,
determining, via a graphing circuitry, one or more graphical representations of the semantic search results based on the one or more classifiers for each result of the semantic search results, and
displaying, via the graphing circuitry to a user interface, each of the one or more graphical representations;
in response to a first selection of a first data point in displayed graphical representations by a user, displaying, via the user interface, the displayed graphical representations with emphasized portions based on the first selection;
after the first selection of the first data point and in response to selection of a second data point by the user, displaying, via the user interface, the displayed graphical representations with emphasized portions based on the selection of the second data and emphasized portions based on overlap between the first selection of the first data point and the selection of the second data point;
in response to a second selection of the first data point:
determining, via the graphing circuitry and a subset of the one or more classifiers for each result of the semantic search results, one or more subset graphical representations, the subset of the one or more classifiers for each result of the semantic search results based on the first data point, and
displaying, via the graphing circuitry to the user interface, each of the one or more subset graphical representations to thereby replace and form the displayed graphical representation; and
in response to a first selection of a list button, displaying, via the graphing circuitry to the user interface, a tabular list based on the semantic search results corresponding to the displayed graphical representation.

2. The method of claim 1, wherein the one or more graphical representations include types of graphs comprising one or more bar graphs, pie charts, line graphs, 3d graphs, clusters, or other chart types.

3. The method of claim 2, wherein the graphing circuitry includes a natural language processing algorithm or model, and wherein the graphing circuitry, via the natural language processing algorithm, generates the cluster based on text from documents included in the semantic search results.

4. The method of claim 3, wherein graphing circuitry generates a second cluster based the second selection.

5. The method of claim 1, wherein graphing circuitry generates generate an additional set of one or more graphical representations corresponding to semantic search results based on additional selections of one or more different data points.

6. The method of claim 1, wherein the semantic search results or subset of the semantic search results and the displayed graphical representations are dynamically linked.

7. The method of claim 1, wherein the first selection of the first data point, the second selection of the first data point, and the selection of the second data point are received from the user interface, and wherein the user interface comprises a graphical user interface or a web user interface displayed on a user's computing device.

8. The method of claim 1, wherein a plurality of graphs are displayed as the one or more graphical representations, each of the plurality of graphs based on one of the one or more classifiers for each result of the semantic search results.

9. The method of claim 8, wherein the one or more classifiers include one or more of a date that a document was uploaded, an author of the document, a region associated with the author of the document, a topic of the document; a context of the document; business unit associated with the document or author of the document; a team associated with the document or author of the document; a department associated with the document or author of the document; competitors associated with the context of the document; a project number associated with the document; or keywords associated with the document.

10. A system for dynamic visualization of semantic search results, the system comprising:
a search circuitry configured to:
determine semantic search results of a set of data based on a received search query, receive pre-extracted metadata based on the set of data, and
determine one or more classifiers for each result of the semantic search results based on the metadata;
a graphing circuitry configured to:
at a substantially same time as a determination of the one or more classifiers for each result:
generate a set of one or more graphical representations of the search results based on one or more of the one or more classifiers for each result, a user input, or one or more user selections,
determine a subset of the one or more classifiers for each result of the semantic search results based on the one or more user selections, and
dynamically link the subset to the set of one or more graphical representations; and
a display circuitry configured to:
display the set of one or more graphical representations on a user interface of a remote computing device, and
in response to selection of a list button, display a dynamically linked subset of the one or more classifiers for each result of the semantic search results on the user interface of the remote computing device.

11. The system of claim 10, wherein the one or more user selections includes selection of one or more portions of the set of one or more graphical representations.

12. The system of claim 11, wherein the graphing circuitry is configured to, in response to selection of one of the one or more portions of the set of one or more graphical representations, update the set of one or more graphical representations based on the selection of one of the one or more portions of the set of one or more graphical representations.

13. The system of claim 12, wherein the graphing circuitry is configured to, in response to an update to the set of one or more graphical representations, dynamically link the set of one or more graphical representations to a subset of the one or more classifiers for each result of the semantic search results based on the selection of one of the one or more portions of the set of one or more graphical representations.

14. The system of claim 10, wherein one of the one or more graphical representations is a cluster.

15. The system of claim 14, wherein the graphing circuitry is configured to form the cluster via a natural language processing circuitry.

16. The system of claim 15, wherein the natural language processing circuitry uses text from each document in the semantic search results.

17. The system of claim 10, wherein the display circuitry is configured to:
in response to selection of a download button, transmit a list of documents stored in the dynamically linked set of search results to the remote computing device via the user interface.

18. A method for generating one or more dynamic graphical representations of semantic search results, the method comprising:
in response to reception of a search query of a set of data by a search circuitry, in substantially real-time:
generating, via the search circuitry, a first set of semantic search results,
receiving pre-extracted metadata based on the set of data to thereby generate one or more classifiers, based on the metadata, for each result of the first set of semantic search results,
determining, via a graphing circuitry, one or more graphical representations of the first set of semantic search results based on the one or more classifiers for each result of the first set of semantic search results, and
displaying, via the graphing circuitry to a user interface, each of the one or more graphical representations of the first set of semantic search results;
in response to a first selection of a first data point in the displayed graphical representations by a user:
generating, via the search circuitry, a second set of sematic search results,
receiving pre-extracted metadata based on the set of data to thereby generate one or more classifiers, based on the metadata, for each result of a second set of semantic search results,
determining, via a graphing circuitry, one or more graphical representations of the second set of semantic search results based on the one or more classifiers for each result of the first set of semantic search results and the one or more classifiers for each result of the second set of semantic search results, and
displaying, via the graphing circuitry to a user interface, each of the one or more graphical representations of the second set of semantic search results; and
in response to a first selection of a list button, displaying, via the graphing circuitry to the user interface, a tabular list based on semantic search results corresponding to currently displayed one or more graphical representations.

19. The method of claim 18, wherein the one or more graphical representations of the second set of semantic search results includes emphasized portions corresponding to the first selection.

20. The method of claim 18, wherein the graphing circuitry bases each portion of the one or more graphical representations of the first set of semantic search results on the one or more classifiers for each result of the first set of semantic search results, and wherein each portion comprises a user selectable area.
